(19) United States
(12) Patent Application Publication
(10) Pub. No.: US 2009/0313759 A1
(43) Pub. Date: Dec. 24, 2009

(54) A Rescuing and Carrying Device

(76) Inventor: Cho Kee Wong, Kowloon (HK)

Correspondence Address: INTELLECTUAL PROPERTY LAW GROUP LLP, 12 SOUTH FIRST STREET, SUITE 1205, SAN JOSE, CA, 95113, US

(21) Appl. No.: 12/438,546

(22) PCT Filed: May 10, 2007
(86) PCT No.: PCT/CN2007/001525

§ 371 Date: Feb. 23, 2009

(30) Foreign Application Priority Data
Aug. 24, 2006 (CN) 200620132715.3

(51) Int. Cl. A61G 1/013

(52) U.S. Cl. 5/627

(57) ABSTRACT

A rescuing and carrying device comprises a supporting portion (1) made of flexible materials, handhold belts (2) made of flexible materials, safety belts (3) made of flexible materials and shoulder belts (5) made of flexible materials. The handhold belts (2), the safety belts (3) and the shoulder belts (5) are fixed on the supporting portion (1) respectively. With being made of flexible materials, the rescuing and carrying device is light and can be folded into smaller one. Additionally, it is convenient for storing and using on battle field or at home. Furthermore, the rescuing and carrying device can be stored under the mattress when not in use and be used as rescuing tools when emergency by fastening the safety belt, especially suitable for battle field or countryside hospital and clinics. With shoulder belts, the present rescuing and carrying device can be lifted or carried on the shoulders of the carriers. It increasingly reduced the possibility of hurt on the carrier's waists, backbones and hands which are resulted from operating only by hands, but the carriers can free their hands to deal with other emergency event.

### FIELD OF THE INVENTION

The invention relates to a rescuing and carrying device, more specifically, to a stretcher-type rescuing and carrying device.

### BACKGROUND OF THE INVENTION

Rescuing and carrying devices are commonly used for rescuing the sick. It has been testified that these devices when applied have enhanced the effect of rescuing greatly. Among these devices, the stretcher-type rescuing and carrying device plays an important role. Traditional stretcher-type rescuing and carrying device generally refers to a stretcher, which comprises a frame and a supporting surface made of flexible materials with certain strength, such as canvas. With the living standard improved and the medical technology developed, functions of the traditional stretcher have been advanced so that they became increasingly integrated. Take it for example, In the stretcher disclosed in Chinese patent CN1457752A there are necessary first-aid device and appliance and power supplier embedded, which can salvage the seriously wounded in locale and ward them when carrying. However, with the stretcher increasingly integrated, the volume, weight and cost thereof are increased correspondingly, which may make the rescue and carry device more difficult to carry and store, and inconvenient to use on battle field or out county, and for resident to store as well.

Chinese patent 2547302Y discloses a rotary foldable stretcher which can be folded into a smaller one for use in daily life and battle. However, this stretcher also has some parts such as a handle, a stretcher rod, a transverse support, surface of rescuing and carrying device, belts for fastening the sick, and gemels etc., thus its structure is complicated and the cost is high. Besides, with the stiff materials such as supporting rod, this stretcher may be difficultly folded, and be inconveniently stored.

Chinese patent CN2552520Y discloses another stretcher for medical use which comprises a left bar, a right bar and several belts in parallel. However, the defects mentioned above haven't been thoroughly overcome yet, since some stiff materials such as the bars are still included in these stretchers.

When carrying the stretcher mentioned above, at least two persons are needed, so it cannot be used under emergency situation with lacking of hands, and this kind of carrying method may slow down the speed for carrying.

### BRIEF SUMMARY OF THE INVENTION

With regard to the above technical problem, the invention is directed to provide a stretcher-type rescuing and carrying device with simple structure and low cost, which is not only light, portable and manpower saving, but can be used to carrying the sick and sick in laying and sitting way.

For the above object, the invention provides a rescuing and carrying device, comprising: a supporting portion made of flexible materials; handhold belts made of flexible materials which is fixed on said supporting portion; and safety belts made of flexible materials which is fixed on said supporting portion and shoulder belts made of flexible materials which is fixed on said supporting portion. With being made of flexible materials, the device is light for reducing the carrying weight and can be folded into smaller one. Additionally, it is suitable for storing and using on battle field or at home. And, the rescuing and carrying device can be stored under the mattress when not in use and be used as rescuing tools when emergency by fastening the safety belt, especially suitable for battle field or countryside hospital and clinics. With shoulder belts, the present rescuing and carrying device can be lifted or carried on the shoulders of the carriers. It increasingly reduced the possibility of hurt on the carrier's waists, backbones and hands which are resulted from operating only by hands, but the carriers can free their hands to deal with other emergency event.

According to the rescuing and carrying device of the invention, the supporting portion is in shape of sheet or bag, whereby the optional shape of the supporting portion can be provided.

According to the rescuing and carrying device of the invention, there are at least two pairs of handhold belts, with each pair spaced a certain distance from each other and fixed on the side borders of the supporting portion. And on the handhold belt, a hand liner which position can be adjusted is placed. In this way, the rescuing and carrying device can be lifted by more persons through raising the handhold belts for rescuing like the common device. Additionally, if allowed, the rescuing and carrying device can be transformed to the traditional stretcher for rescuing like the common rescuing and carrying device through inserting a hard rod-shaped stuff into the handhold belt.

According to the rescuing and carrying device of the invention, the safety belts optionally comprise shoulder safety belts, chest safety belts, waist safety belts and leg safety belts. In this way, when carried the corresponding part of the sick can be fixed on the device, for preventing them from out of the device accidently or due to rumble-tumbling because of the rough road, which resulted to the unnecessary hurt or aggravate the injury.

According to the rescuing and carrying device of the invention, one end of the shoulder safety belt is fixed on the supporting portion, and the other end is connected at one position of the waist safety belt which can be adjusted. Whereby, the upper body of the sick can be fixed stably. In addition, there are two leg safety belts fixed to the waist safety belt respectively so that the sick can be rescued when sitting. In this way, the sitting pose of the sick can be rooted and the two legs cannot be over swung.

According to the rescuing and carrying device of the invention, there are one pair of the shoulder belts respectively fixed on the both sides of the supporting portion, with one end mounted the top border of the supporting portion and the other end mounted on the middle-lower part of the side borders.

With shoulder belts, the present rescuing and carrying device can be lifted or carried on the shoulders of the carriers. It increasingly reduced the possibility of hurts on the carriers' waists, backbones and hands, which are resulted from operating only by hands, but also the carriers can free their hands to deal with other emergency event. Through using the structure, it is convenient to carry the sick which are unconscious, and it is avoided that the device cannot be balanced by the carrier due to the imbalance in weight of the unconscious body. Moreover, carrying the sick from two sides can also reduce the effect on the carry speed.

According to the rescuing and carrying device of the invention, there are shoulder gaskets placed on the shoulder belts, in which the position can be adjusted. By using this structure, the comfort of the carriers' back can be increased and the possibility of injuring the carriers shoulder can be reduced.

According to the rescuing and carrying device of the invention, there is a length adjustable member on the shoulder belt. Carriers can adjust the length of the belts according to the height of the sick, or adjust it freely even when carrying without offloading the sick, so as to eliminate the unnecessary injury to them and send them to the ambulance as soon as possible.

According to the rescuing and carrying device of the invention, the rescuing and carrying device also includes a drag belt made of flexible materials, which is fixed on the supporting portion. With this structure, the rescuing and carrying device can be dragger by a single carrier, so it is suitable for the situation in which there is lack of hands, especially for the situation where persons is escaping and evacuated so as to escape the disaster field with the least carrier as soon as possible.

According to the rescuing and carrying device of the invention, two ends of the drag belts are fixed on the upper side or lower side of the supporting portion so that the carriers can drag the device in different directions.

According to the rescuing and carrying device of the invention, the device also comprises a protection cover which is connected to the supporting portion for forming a protection sheath. In addition, a slide fastener is arranged on the protection cover to open the sheath, so it is suitable especially for carrying the corpse. Being comparatively airproof, it can reduce the effusion of body smell and prevent from liquid flowing out of the device. Furthermore, the material and process required for enwrapping the corpse can be saved, and the carrying weight can be decreased.

According to the rescuing and carrying device of the invention, a window is arranged on the protection sheath, so that the identity of the decedent can be recognized without opening the protection sheath.

According to the rescuing and carrying device of the invention, the safety belts are set in the inner part formed by the protection cover and the supporting portion. In this way, the corpse can be fixed into the protection sheath formed by the supporting and the protection cover.

According to the rescuing and carrying device of the invention, it also includes the protection cover, which length is smaller than that of the supporting portion, and the bottom border and side borders of the cover are respectively connected to those of the supporting portion. And, there is an opening between the top borders of the cover and the supporting portion. In this way, the supporting portion together with the protection cover can form a body protection sheath. By putting the part of the body of the sick into the cover, it can avoid the quick loss of the body heat. With the protection sheath, it can overcome the inconvenience resulted from the need of taking the rescuing and carrying device and the blankets for the carriers. In the rescuing and carrying device, the supporting porting is in shape of rectangular. Thus, it is conveniently manufactured.

According to the rescuing and carrying device of the invention, the supporting portion has a shape which is corresponded to the shape of the backs and legs of persons. In addition, the device also comprises a back supporting portion, and a leg supporting portion on which leg fastener belts made of flexible materials are placed. With this structure, it is suitable for one person to carry the sick. Therefore, it is very useful when emergency and the hands are very few.

According to the rescuing and carrying device of the invention, the shoulder belts further comprise a shoulder fastener belt and a waist fastener belt which are set on the supporting portion. With this structure, the carrier can carry the sick on his back stably through back to back by oneself, and the two hands can deal with every event without any limitation. Meanwhile, the sick who faces to the backward of the carrier can watch the surroundings and his hands can deal with every event without any limitation. Especially, it is suitable for the device to carry the sick, which body is partly hurt but conscious is clear, and the hands can still fight when the battle taking place.

According to the rescuing and carrying device of the invention, the safety belts comprise shoulder safety belts, waist safety belts and leg safety belts, wherein the shoulder safety belts and waist safety can be used as shoulder fastener belts and waist fastener belts at the same time. With this structure, the carrier can carry the sick on his back stably and his hands can deal with the emergency.

According to the rescuing and carrying device of the invention, the flexible materials are non-woven fabric. With this feature, the device is waterproof, mildew-proof and ventilate.

### BRIEF DESCRIPTION OF THE DRAWINGS

FIG. 1 is a front view illustrating a rescuing and carrying device in accordance with the first embodiment of the present invention;

FIG. 2 is a state diagram illustrating a rescuing and carrying device in use in accordance with the first embodiment of the present invention;

FIG. 3 is a front view illustrating a rescuing and carrying device in accordance with the second embodiment of the present invention;

FIG. 4 is a front view illustrating a rescuing and carrying device with the slide fastener open in accordance with the first embodiment of the present invention;

FIG. 5 is a front view illustrating a rescuing and carrying device in accordance with the third embodiment of the present invention;

FIG. 6 is a back view illustrating a rescuing and carrying device in accordance with the first embodiment of the present invention;

FIG. 7 is a front view illustrating a rescuing and carrying device in accordance with the fourth embodiment of the present invention;.

FIG. 8 is a back view illustrating a rescuing and carrying device in accordance with the fourth embodiment of the present invention;

FIG. 9 is a state diagram illustrating a rescuing and carrying device in use in accordance with the fourth embodiment of the present invention;

FIG. 10 is a front view illustrating a rescuing and carrying device in accordance with the fifth embodiment of the present invention;

FIG. 11 is a back view illustrating a rescuing and carrying device in accordance with the fifth embodiment of the present invention;

FIG. 12 is a state diagram illustrating a rescuing and carrying device in use in accordance with the fifth embodiment of the present invention;

FIG. 13 is a front view illustrating a rescuing and carrying device in accordance with the sixth embodiment of the present invention;

FIG. 14 is a state diagram illustrating a rescuing and carrying device in use in accordance with the sixth embodiment of the present invention.

### DETAILED DESCRIPTION OF THE DRAWINGS

The preferred embodiments of the prevention will be described in detail with reference to the accompanying drawings. Wherein, the similar numeric refers to the similar part.

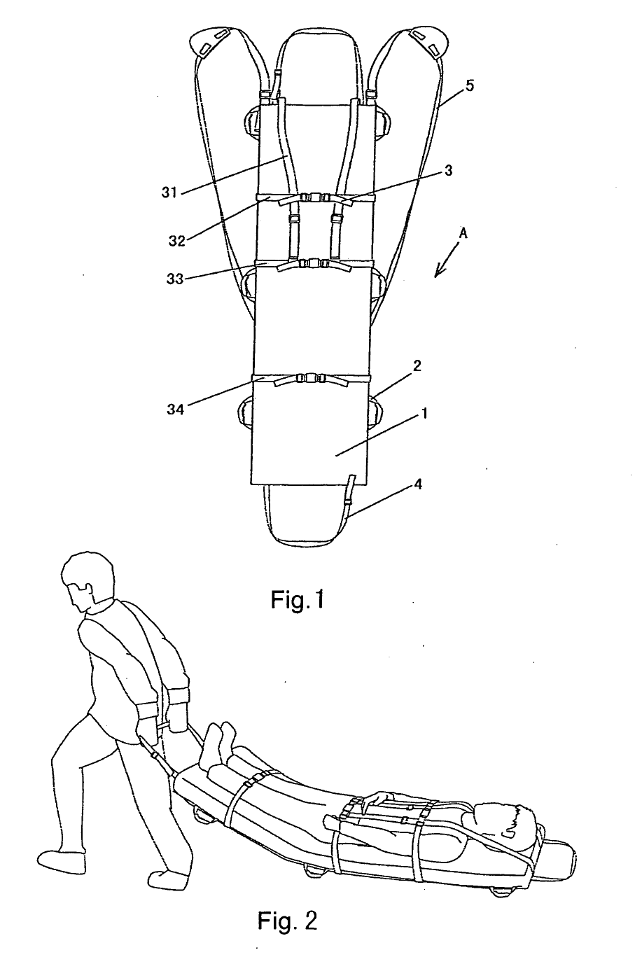

See FIG. 1 and FIG. 2, a rescuing and carrying device in accordance with the first embodiment of the present invention is shown. The rescuing and carrying device A of the embodiment comprises: a supporting portion 1, and handhold belts 2, safety belts 3, drag belts 4 and shoulder belts 5, which are fixed on the supporting portion 1.

The supporting portion 1 has a shape of rectangle, and includes a top border, a bottom border and two side borders. The length of the supporting portion is somewhat longer than the height of the ordinary person and the width is somewhat wider than that of ordinary person. Depending on demands, the supporting portion can be made into single sheet or bag. The single sheet can be designed as a single layer of thin fabric, or alternatively, flexible materials with certain thickness can be chosen to enhance the comfort of using the supporting portion. The selection of materials varies with the practical application.

Herein, there are three pairs of handhold belts 2, with each pair fixed on the upper end, middle part and lower end of the supporting portion's two side borders. And, a hand liner, the position of which can be adjusted, is placed on the handhold belt 2.

The safety belt 3 comprise two shoulder safety belts 31, a chest safety belt 32, a waist safety belt 33 and a leg safety belt 34, on each of which an adjusting member is arranged to enable their length to be adjusted. The upper ends of the two shoulder safety belts are fixed on the top border of the supporting portion 1 respectively, the lower ends of the two shoulder safety belts respectively go through the chest safety belt and are fixed on the waist safety belt 33, in which the fixed position is adjustable. The chest safety belt 32, the waist safety belt 33 and the leg safety belt 34 all have buckles which can be opened and closed. Here, the safety belts 3 cooperate to fasten the sick on the rescuing and carrying device.

Wherein, it is designed to have two drag belts 4, with each fixed respectively on the top border and the bottom border of the supporting portion 1. In addition, adjusting members are also placed on the drag belts to adjust the length depending on the needs. The two ends of the drag belt 4 are respectively fixed at a different position of the corresponding border, and there are the hand liners with their position adjustable placed on the drag belt.

Wherein, it is designed to have two shoulder belts 5, with each arranged on the two side borders of the supporting portion 1. The upper end of the belt is fixed on the end of the top border, and the lower end is fixed on the lower-of-middle part of the side border, which corresponds to the lower part of the haunch of the sick. Moreover, the length adjusting members and the shoulder gasket are arranged on the shoulder belts 5.

Each of the above components is made of flexible materials which have certain tenacity.

When using the device, open each buckle 3 of the safety belt 3 and put the sick horizontally on the supporting portion 1; then buckle all the buckles 3 to make the sick be fixed stably on the supporting portion 1; two carriers then put the shoulder belts 5 on the shoulder to carry the sick; Alternatively, two or more carriers can take the handhold belts 2 and/or drag belts 4 for carrying. Where the hands are not enough, the drag belts 4 can also be taken by one carrier to carry, and then the carrier can decide to draw the head part belt or the leg part belt 4 according to the situation at that time.

The rescuing and carrying device A of the present embodiment has following advantages:
1. With the supporting portion made of flexible materials, the rescuing and carrying device can be stored under the mattress, and in an emergency, the device can be used as rescuing equipment by just fastening the belt.
2. With the handhold belts, the device can be carried by more carriers through taking the handhold belts if the hands enough.
3. With the safety belt, the sick can be fastened stably on the device so as to prevent them out of the device, accidently or due to rumble-tumbling because of the rough road when carrying, which results to the needless injury.
4. With the drag belts, the device can be managed by one carrier through towing the drag belts when the hands are not enough.
5. Because the device has shoulder belts, the carrier can carry the belts on the shoulders and simultaneously other arm can lift the handhold belts. In this way, It can reduce significantly the possibility of hurts on the carriers' waists, backbones and hands, which are resulted from operating only by hands, but also the carriers can free their hands to deal with other emergency event. Through using the structure, it is very convenient to carry the sick who are unconscious, and it is avoided that the device cannot be balanced by the carrier due to the imbalance in weight of the unconscious body. And the shoulder sheath can enhance the comfort of carrying. Moreover, the length adjustable member on the shoulder belt can be adjusted to make the length of the belts match the height of the sick, or it can be adjusted freely even when carrying without offloading the sick, so as to eliminate the unnecessary injury to them and send them to the ambulance as soon as possible.

The present embodiment is suitable for using in hospitals or clinic, especially in battle field hospitals or clinics and field aid stations etc., where persons is escaping and evacuated so as to escape the disaster field with the least carrier as soon as possible.

The second embodiment of the invention will be described as follows.

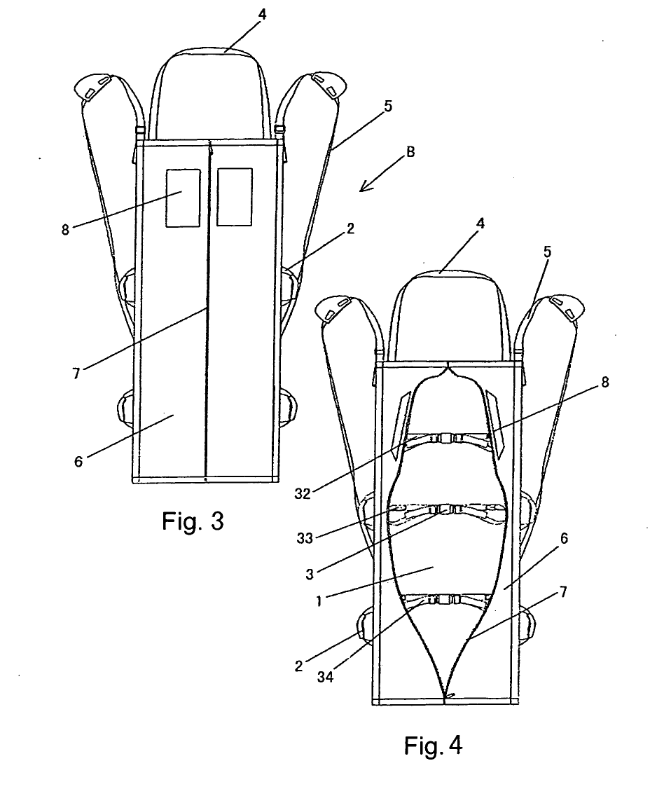

FIG. 3 and FIG. 4 illustrate a rescuing and carrying device in accordance with the second embodiment of the present invention. The rescuing and carrying device B of the present embodiment comprises: a supporting portion 1, and handhold belts 2, safety belts 3, drag belts 4 and shoulder belts 5, which are fixed to the supporting portion 1.

Here, the structure of the supporting portion 1 is the same as that of the first embodiment.

There are two pairs of handhold belts 2 fixed in pairs on the middle part and lower end of the supporting portion's two side borders. And, a hand liner, the position of which can be adjusted, is placed on the handhold belt 2.

The safety belts 3 comprise a chest safety belt 32, a waist safety belt 33 and a leg safety belt 34, which structure is respectively same as that of the first embodiment. The upper ends of the two shoulder safety belts are fixed on the top border of the supporting portion 1 respectively.

Here, the device is designed to have one drag belt 4, on which the adjusting members are arranged for changing the length depending on the needs. The two ends of the drag belts 4 are fixed respectively on the two ends of the shorter border of the supporting portion 1. Alternatively, there is a hand liner, the position of which can be adjusted, arranged on the drag belt 4.

Here, the shoulder belts 5 are same as those of first embodiments.

The rescuing and carrying device B of the embodiment also includes a protection cover 6, which length and width are equal to or somewhat larger than those of the supporting portion 1. The four borders of the protection cover are connected to those of the supporting portion for forming a close protection sheath. Also, there is a slide fastener 7 which length is same as that of the protection cover arranged on the middle of the protection cover 6 for opening the sheath. On both sides of the slide fastener 7, there are two windows 8 placed, which are covered by transparent materials or ventilate silk for recognizing the decedent identity without opening the protection sheath.

Each of the above components is made of flexible materials with certain tenacity.

When using the device, open the safety belt 3 and put the sick horizontally on the supporting portion 1; then buckle the safety belts 3 to make the sick be fixed stably on the supporting portion 1; and then the sick is closed into the protection sheath through sliding the slide fastener up; the carrier can put the shoulder belts 5 on the shoulder and hold the handhold belts 3 depending on the needs for lifting the sick. Where the sick needs to be carried in lay way, the shoulder belts 5 can be in no use, but only the drag belt 4 and the handhold belts 2 are used for carrying. Where the hands are not enough and in emergency, the drag belts 4 can also be taken by one carrier to carry.

The rescuing and carrying device B according to the embodiment further has the following advantages besides those of the first embodiment:
1. The safety belts inside the protection sheath can make the decedent be fixed stably, for preventing the carrying speed slowing down because of the shaking of the device during carrying.
2. The decedent identity can be recognized through the transparent window directly without opening the protection sheath.
3. The structure is especially suitable for carrying corpse. Being comparatively airproof, it can reduce the effusion of body smell and prevent from liquid flowing out of the device. Furthermore, the material and process required for enwrapping the corpse can be saved, and the carrying weight can be decreased. The safety belts can fix the corpse for balancing the weight on the device to make the carrying easy. The transparent windows are used conveniently for indentifying the corpse.

The third embodiment of the invention will be described as follows.

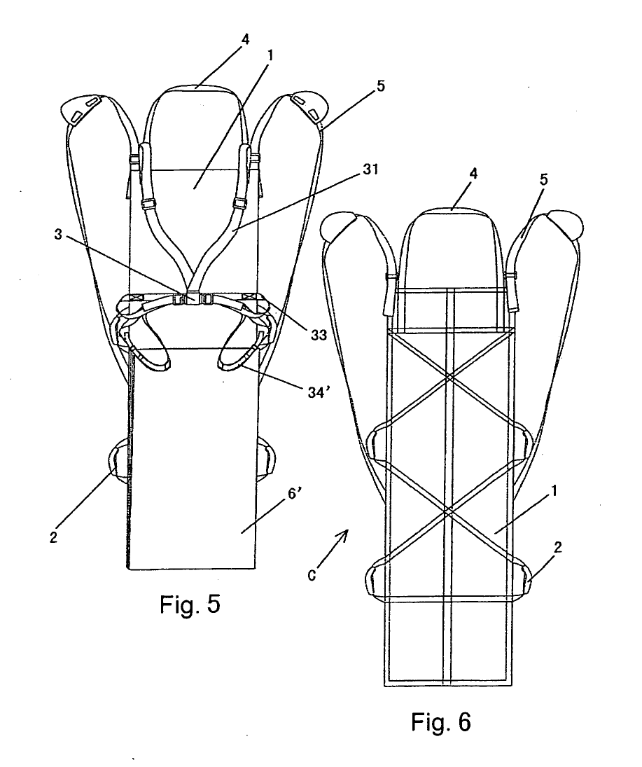

FIG. 5 and FIG. 6 illustrate a rescuing and carrying device in the third embodiment of the present invention. The rescuing and carrying device C of the embodiment comprises: a supporting portion 1, handhold belts 2, safety belts 3, a drag belt 4 and shoulder belts 5; wherein the handhold belts 2, the safety belts 3, the drag belt 4 and the shoulder belts 5 are fixed to the supporting portion 1.

The structure of the supporting portion 1 is the same as that of the second embodiment.

The structures of the handhold belts 2 are the same as those of second embodiment.

Here, the safety belts 3 comprise two shoulder safety belts 31, a waist safety belt 33 and a leg safety belt 34′; and there are adjusting members placed on the safety belts 3 to adjust the length thereof depending on the needs. The upper ends of the two shoulder belts 31 are respectively fixed on the top border of the supporting portion 1, and the lower ends are fixed on some part under the waist belt 33. The waist safety belt 33 is divided into two segments, one end of which is respectively fixed on the both side borders of the supporting portion 1, and on the other end of which is placed a buckle for buckling them together. There are two leg safety belts 34′, with each fixed on the waist safety belt 33.

The number of the drag belt 4 is one, and it is placed on the top border of the supporting portion 1, with the two ends of the belts fixed on those of the top border.

The shoulder belts 5 are the same as those of second embodiments.

The rescuing and carrying device of the embodiment also includes a protection cover 6′, which width are equal to or somewhat larger than those of the supporting portion 1, and which length is substantially equal to that of the body leg. The bottom border of the protection cover 6′ is connected to that of the supporting portion, and the two side borders of the protection cover 6′ are ruffled and connected to those adjacent to the bottom border of the supporting portion 1, thereby a close protection sheath which has an opening and occupies certain room is formed.

The length of the protection cover 6′ can be adjusted according to the specific part of human body. For example, if other parts of body except for the head need to be protected fully, the length of the protection cover 6′ can be designed to be somewhat larger than that of body from the shoulder to the foot.

The above components are made of flexible materials with some tenacity.

When using the device, open the shoulder safety belt 31 and waist safety belt 32 first, and put the sick horizontally on the supporting portion 1, with the legs inside the protection sheath; and then, buckle the shoulder safety belt 31 and the waist safety belt 32 for fix the sick on the supporting portion stably. After that, carriers can put the shoulder belts on their back and hold the handhold belts 3 depending on the needs to carry the sick. If the sick needs to be carried in lay way, the shoulder belts 5 can be in no use, but only the drag belt 4 and the handhold belts 2 are used for carrying. Where the hands are not enough and in emergency, the drag belts 4 can also be taken by one carrier to carry. Besides, the sick can sit outside the protection sheath with the legs out thereof, and then the shoulder safety belt 31, waist safety belt 32 and leg safety belt 34′ are fastened for carrying.

The rescuing and carrying device C according to the embodiment further has the following advantages besides those of the first embodiment:
1. With the structure being different from that of the first embodiment, the leg safety belt can fix the sitting position of the sick for preventing the two legs swinging, thus the stability can be enhanced.
2. With the protection sheath for the body, specific part of the sick can be protected for preventing the loss of body heat.
3. With the special structure of the embodiment, the leg safety belt can fix the sitting position of the sick for preventing the two legs swinging, thus the stability can be enhanced. The unnecessary hurt to the sick can be avoided.
4. With the rescuing and carrying device being designed specially, the respiration valve of the sick can be opened naturally for breathing freely, because the head is raised backward when he/she is carried. It complies with the requirement for rescuing.

The fourth embodiment of the invention will be described.

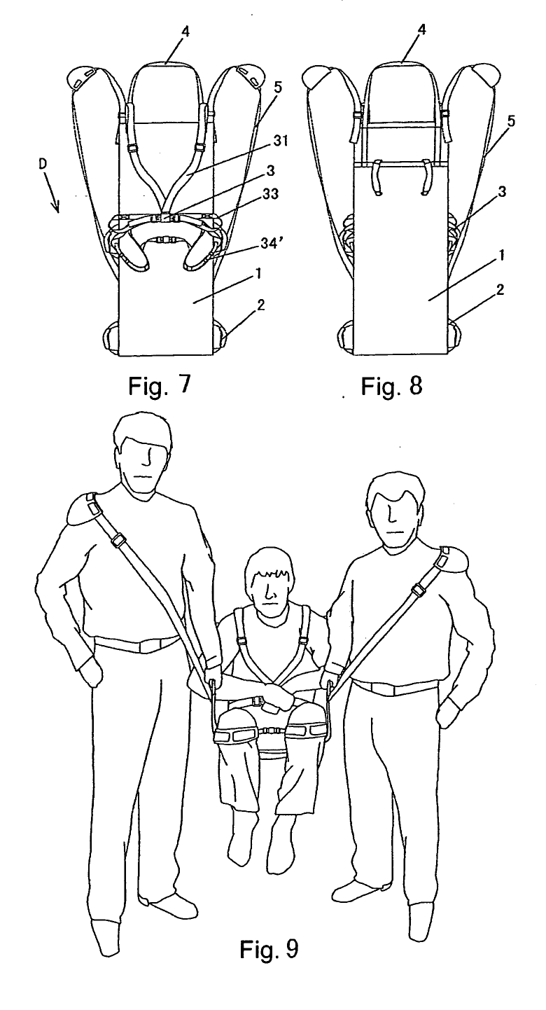

FIG. 7, FIG. 8 and FIG. 9 illustrate a rescuing and carrying device in accordance with the fourth embodiment of the present invention. The rescuing and carrying device D of the embodiment comprises: supporting portion 1, handhold belts 2, safety belts 3, a drag belt 4 and shoulder belts 5; wherein the handhold belts 2, the safety belts 3, the drag belt 4 and the shoulder belts 5 are fixed on the supporting portion 1.

The supporting portion 1 has a shape of rectangle, which length is equal to that of body from the head to the foot, and width is somewhat larger than that of the human back.

Here, the number of the handhold belts 2 is one pair, which are fixed respectively on the lower part of the two side borders of the supporting portion 1. On the handhold belts 2, there are slidable hand liners arranged.

And, the safety belts 3 comprise two shoulder safety belts 31, a waist safety belt 33 and a leg safety belt 34′, on which adjusting members are arranged for adjusting the length of the belts depending on the need. The shoulder safety belt 31 and waist safety belt 33 are buckled at the waist part of the sick to fasten the upper part of the sick stably on the supporting portion 1; the leg safety belts 34′ are used to fix the sitting position of the sick.

The number of the drag belt 4 is one, and it is placed on the top border of the supporting portion 1, with two ends fixed on the both ends of the border.

Two shoulder belts 5 are set on the two side borders of the supporting portion 1 respectively, which upper end is fixed on the joint of the upper end of the side border and the top border, and lower end on the lower-of-middle part of the side border. Moreover, the length adjusting members and the slidable shoulder gaskets are arranged on the shoulder belts 5.

Each of the above components is made of flexible materials which have certain tenacity.

When using the device, open the safety belt 3 and let the sick lie or sit on the supporting portion 1; then buckle all the buckles 3 to make the sick be fixed stably on the supporting portion 1; two carriers then put the shoulder belts 5 on the shoulder to carry the sick; Alternatively, two or more carriers can take the handhold belts 2 and/or drag belts 4 for carrying. Where the hands are not enough, the drag belts 4 can also be taken by one carrier to carry.

The rescuing and carrying device D according to the embodiment further has the following advantages:
1. Because the device has shoulder belts, the carrier can carry the belts on the shoulders and simultaneously other arm can lift the handhold belts. In this way, It can reduce significantly the possibility of hurts on the carriers' waists, backbones and hands, which are resulted from operating only by hands, but also the carriers can free their hands to deal with other emergency event. Through using the structure, it is very convenient to carry the sick who are unconscious, and it is avoided that the device cannot be balanced by the carrier due to the imbalance in weight of the unconscious body. And the shoulder sheath can enhance the comfort of carrying and decrease the possibility of hurt on back part. Moreover, the length adjustable member on the shoulder belt can be adjusted to make the length match the height of the sick, or it can be adjusted freely even when carrying without offloading the sick, so as to eliminate the unnecessary injury to them and send them to the ambulance as soon as possible.
2. With the special structure in the embodiment, the leg safety belt can fix the sitting position of the sick for preventing the unnecessary load on the back resulted from body swaying too much, so it can increase the stability of the sitting position when the sick is carried and prevent any unnecessary hurt to him/her.
3. With the handhold belt, the carriers can stable the device to prevent any swaying during the carry when they are putting the shoulder belts on their back.
4. With the drag belt, where the hands are not enough and in emergency, the drag belt can also be taken by one carrier to carry.
5. With the rescuing and carrying device being designed specially, the respiration valve of the sick can be opened naturally for breathing freely, because the head is raised backward when he/she is carried. It complies with the requirement for rescuing.

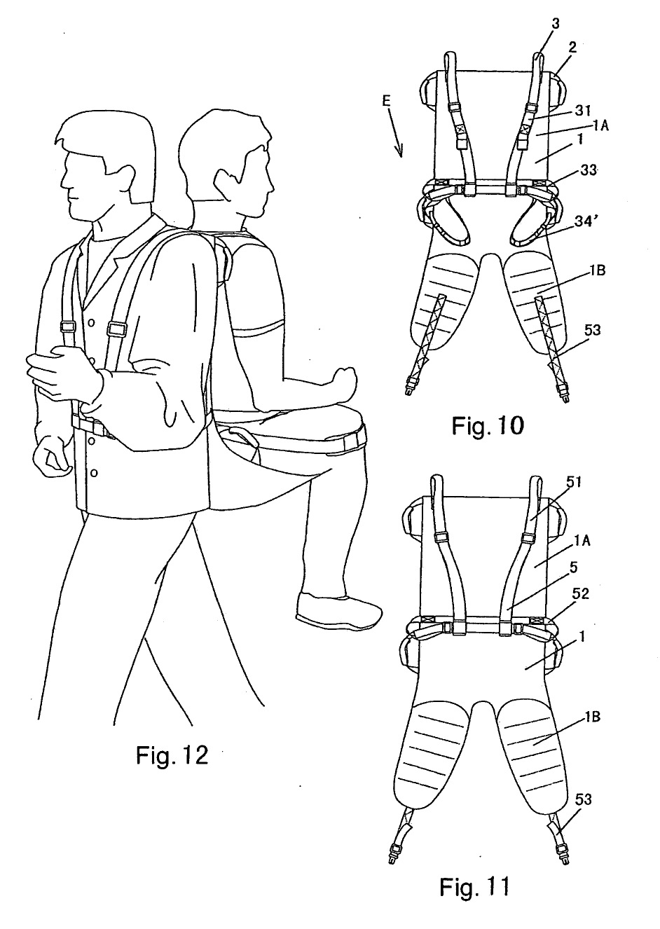

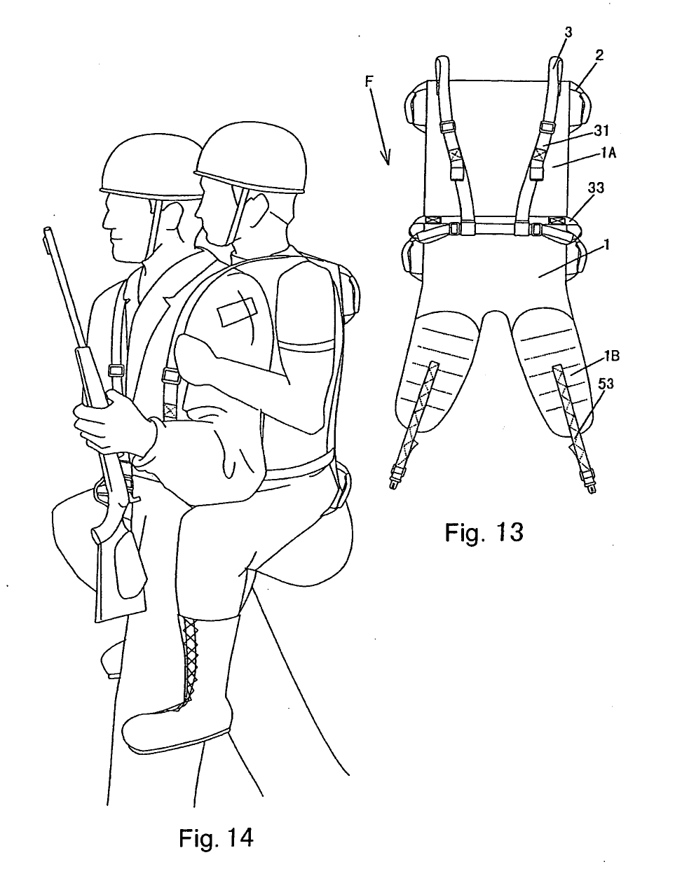

FIG. 10, FIG. 11 and FIG. 12 illustrate a rescuing and carrying device of the fifth embodiment of the invention. The rescuing and carrying device E of the embodiment comprises: supporting portion 1, handhold belts 2, safety belts 3 and shoulder belts 5; wherein the handhold belts 2, the safety belts 3 and the shoulder belts 5 are fixed on the supporting portion 1.

The length of the supporting portion 1 is almost equal to that of body from the head to the foot and the width thereof is almost equal to the width of the human back. The supporting portion 1 has a shape matching with that of the back and leg of human body. And, the supporting portion 1 further comprises a back supporting portion IA and a leg supporting portion IB. On the leg supporting portion, there are leg fastener belts 53 made of flexible materials placed, which end has a buckle for using to connect with the waist safety belt 33.

There are two pairs of handhold belts 2 fixed in pairs on the upper and middle part of the two side borders of the supporting portion 1.

The safety belts 3 comprise shoulder safety belts 31, a waist safety belt 33 and a leg safety belt 34′. One end of the shoulder safety belt 31 is fixed on the top border of the supporting portion 1, and the other end is connected to the waist safety belt 33, in which the position of the joint can be adjusted. There are two leg safety belts 34′, with each fixed on the waist safety belt 33. And, on all the safety belts, there are adjusting members set for adjusting length thereof.

The shoulder belts 5 comprise shoulder fastener belts 51 and a waist fastener belt 52 which are fixed on the back of the supporting portion 1. One end of the shoulder fastener belt 51 is fixed on the top border of the supporting portion 1, and the other end is connected to the waist fastener belt 52. There are adjusting members set on the shoulder fastener belts 51 and the waist fastener belt 52 to adjust the length thereof. In addition, the waist fastener belt 52 is divided into two segments, one end of which are respectively fixed on the both side border of the supporting portion 1. And on the belts, there are buckles placed which can be opened or closed.

Each of the above components is made of flexible materials which have certain tenacity. When using the device, open the safety belt 3 and adjust its length to adapt to that of the body; then put the supporting portion Ion the back of the sick and fasten the waist safety belt 33; let the shoulder safety belts round the shoulder and be fixed on the waist safety belt 33; then open the shoulder fastener belt 51 and waist fastener belt 52, the carriers and the sick stand with back to back, and the shoulder being fixed by the shoulder fastener belt 51. After the waist fastener belt 52 is fastened, the leg fastener belt 53 is put on the legs of the sick and the leg safety belt 34′ is put for fixing the sitting position of the sick through adjusting the position of its adjusting members.

By using such a device, carriers can put the sick on the back so as to free their hands to deal with any emergency. At the same time, the sick on the back of the carriers can watch the situation behind them with the hands having no limit to deal with any emergency situation. This device is especially suitable for carrying those partly wounded but the hands can fight in the battle field.

The sixth embodiment of the invention will be described as follows.

FIG. 13 and FIG. 14 illustrate a rescuing and carrying device in accordance with the sixth embodiment of the present invention. The rescuing and carrying device F of the embodiment comprises: a supporting portion 1, handhold belts 2, safety belts 3 and shoulder belts 5, wherein the handhold belts 2, the safety belts 3 and the shoulder belts 5 are fixed on the supporting portion 1.

The structure of the supporting portion 1 is the same as that of the fifth embodiment.

The structure of the handhold belts 2 are the same as those of the fifth embodiment.

The safety belts 3 comprise shoulder safety belts 31 and a waist safety belt 33. One end of the shoulder safety belts 31 are fixed on the top border of the supporting portion 1 and the other end is connected to the waist safety belt 33, in which the position of the joint can be adjusted. And, on all the safety belts, there are adjusting members set for adjusting length thereof

In the embodiment, the shoulder safety belts 31 correspond to the shoulder fastener belts 51 in the shoulder belts 5 and the waist safety belt 33 corresponds to the waist fastener belt 52 in the shoulder belts 5.

Each of the above components is made of flexible materials which have certain tenacity.

When using the device, open the safety belts 3 first, and adjust the length thereof to make sure that the belt can be bonded onto the sick; then, put the supporting portion 1 on the back of the sick and let the sick grovel onto the carrier's back, and buckle the waist safety belt 33 to fix the sick and the carrier together; subsequently, fix the shoulder safety belt 31 to the waist safety belt 33 at the waist of the carrier through making the shoulder safety belt 31 cross the shoulders of the sick and the carriers; after that, pull up the leg fastener belt 53 for being buckled on the waist safety belt 33, and raise the legs of the sick for carrying him/her on the back of the carrier.

By using the rescuing and carrying device F, it makes sure that the carriers can carry the sick on their backs stably, while their hands are free to deal with any emergency situation, thus the device is especially suitable for battle use.

1. A rescuing and carrying device, characterized in comprising:
a supporting portion (1) , with shape of sheet or bag, made of flexible materials;
shoulder belts (5) made of flexible materials and fixed on said supporting portion (1);
at least one pair of handhold belts (2) made of flexible materials, which are fixed on the side borders of said supporting portion (1), with one of said handhold belts spaced a certain distance from the other; and
Safety belts (3) made of flexible materials, which are fixed on said supporting portion (1).

2. The rescuing and carrying device according to claim 1, characterized in further including at least one drag belt (4) made of flexible materials fixed on said supporting portion (1), in which, two ends thereof are fixed on the top border or bottom border of said supporting portion (1).

3. The rescuing and carrying device according to claim 1, characterized in further including a hand liner, the position of which is adjustable, placed on said handhold belt (2).

4. The rescuing and carrying device according to claim 1, characterized in that, said safety belts comprise: shoulder safety belts (31) and a waist safety belt (33), in which one end of said shoulder safety belts (31) is fixed on said supporting portion (1) and other end is connected to said waist safety belt (33) with the connection position being adjustable.

5. The rescuing and carrying device according to claim 4, characterized in that, said safety belts further include a chest safety belt (32) which is in parallel with said waist safety belt (33) and across said shoulder belts (31).

6. The rescuing and carrying device according to claim 4, characterized in that, said safety belts further includes two leg safety belts (34) fixed on said waist safety belt (33) respectively, and connection belts are optionally placed between said leg safety belts (34).

7. The rescuing and carrying device according to claim 1, characterized in that, two ends of said shoulder belts (5) are fixed on both sides of said supporting portion (1) respectively.

8. The rescuing and carrying device according to claim 1, characterized in that, one end of said shoulder belt (5) is fixed on the end of the top border of said supporting portion (1), and the other end is fixed on the lower-of-middle of the side border of said supporting portion (1).

9. The rescuing and carrying device according to claim 1, characterized in that there are shoulder gaskets, the position of which can be adjusted, arranged on said shoulder belts (5).

10. The rescuing and carrying device according to claim 1, characterized in that there is a length adjustable member arranged on said shoulder belt (5).

11. The rescuing and carrying device according to claim 1, characterized in further comprising a protection cover (6) made of flexible materials with good air permeability, which is connected with the four borders of said supporting portion (1) to form a protection sheath, on which there is a slide fastener or button for opening said sheath and a transparent window arranged.

12. The rescuing and carrying device according to claim 11, characterized in that, said safety belts are arranged in the inner part of said protection sheath.

13. The rescuing and carrying device according to claim 1, characterized in further comprising a protection cover (6) made of flexible materials, the length of which is smaller than that of said supporting portion (1), and the bottom border and the side borders of which are respectively connected to those of the supporting portion (1), with an opening between the top borders of said cover (6) and said supporting portion (1).

14. The rescuing and carrying device according to claim 1, characterized in that said supporting portion (1) is in shape of rectangle.

15. The rescuing and carrying device according to claim 1, characterized in that, said supporting portion (1) has a shape which is corresponded to the shape of the backs and legs of persons, and comprises a back supporting portion, and a leg supporting portion on which leg fastener belts made of flexible materials are placed

16. The rescuing and carrying device according to claim 15, characterized in that said shoulder belts (5) further comprise a shoulder fastener belt and a waist fastener belt which are set on said supporting portion.

17. The rescuing and carrying device according to claim 1, characterized in that said safety belts (3) comprise shoulder safety belts (31), a waist safety belt (33) and leg safety belts (34), wherein said shoulder safety belts (31) and said waist safety belt (33) can be used as shoulder fastener belts and waist fastener belts in said shoulder belts (5) at the same time.

18. The rescuing and carrying device according to any one of claim 16 or 17, characterized in that said safety belts (3) further comprise a chest safety belt (32) placed above said waist safety belt (33) in parallel with each other.
